(19) United States
(12) Patent Application Publication
(10) Pub. No.: US 2013/0073301 A1
(43) Pub. Date: Mar. 21, 2013

(54) MEDICAL CLASSIFICATION MAPPING FOR FINANCIAL NEUTRALITY

(71) Applicants: Gururaj B. Rao, Mumbai (IN); Sambit Sarangi, Bhubaneswar (IN)

(72) Inventors: Gururaj B. Rao, Mumbai (IN); Sambit Sarangi, Bhubaneswar (IN)

(73) Assignee: Infosys Limited, Bangalore (IN)

(21) Appl. No.: 13/315,124

(22) Filed: Dec. 8, 2011

(30) Foreign Application Priority Data
Sep. 20, 2011 (IN) 3245/CHE/2011

(51) Int. Cl. G06Q 50/22; G06Q 40/08

(52) U.S. Cl. 705/2

(57) ABSTRACT

Various technologies related to achieving financial neutrality in light of transition from one medical classification system to another are described. Mappings between and among codes such as diagnosis codes, procedure codes, and payment codes can be explored and chosen based on comparison of financial impact among candidate codes. To increase performance, weighting in favor of principal codes can be supported. Such weighting can be throttled for adjustment. Other features, including generating replacement codes based on chosen mappings, can be implemented.

### BACKGROUND

A recurring problem plaguing the medical, healthcare and health insurance industries is conforming to the ever-changing requirements of healthcare legislation and keeping up with constantly evolving industry classification systems. Changes in legislation and classification systems typically require healthcare providers and health insurance providers to change the way healthcare information in classified, recorded and communicated, which in turn requires significant changes to the systems used for carrying out these tasks.

Modern healthcare legislation can specify protocols for classifying, recording and communicating information within the healthcare industry. For example, Title II (Administrative Simplification provisions) of the Health Insurance Portability and Accountability Act (HIPAA), enacted by the U.S. Congress in 1996, requires the establishment of national standards for electronic healthcare transactions and national identifiers for providers, health insurance plans, and employers. After Jul. 1, 2005, most medical providers that file electronically were required to file their electronic claims using the HIPAA standards to be paid. On Jan. 1, 2012, the newest version of HIPAA, version 5010, is scheduled to become effective, replacing version 4010.

Among various changes, HIPAA 5010 allows for the larger field size of the International Classification of Diseases, 10th Revision, Clinical Modification (ICD-10-CM), provided by the Centers for Medicare and Medicaid Services (CMS) and the National Center for Health Statistics (NCHS), for medical coding and reporting in the United States. The ICD-10-CM is a classification system for classifying diagnoses and procedures related to patient visits in healthcare settings. The ICD-10-CM is based on the ICD-10, the statistical classification of disease published by the World Health Organization (WHO), which replaces the older classification system ICD-9.

Keeping up with changes in legislation and industry classification systems is important for healthcare providers and health insurance providers because conformance to these changes can be necessary to receive payment for medical claims from a payer of medical claims such as Medicare. To determine an amount to pay for a billed medical claim, providers often use a standard set of codes called Diagnosis-Related Group (DRG) codes, which are based on the ICD codes. Changes to the ICD coding systems can cause changes in the way the DRG codes are calculated, and thus changes in the payment amounts. It can be difficult for providers to modify their software systems to account for these changes and ensure proper payments for medical claims.

And, inevitably, there will be further changes to healthcare legislation and industry classification systems in the future.

### SUMMARY

Various technologies related to achieving financial neutrality in light of transition from one healthcare classification system to another are described. Mappings between codes such as diagnosis codes, procedure codes, and payment codes can be explored and chosen based on comparison of financial impact among candidate replacement codes. To increase performance, weighting in favor of principal codes can be supported. Such weighting can be throttled for adjustment. Other features, including generating replacement codes based on chosen mappings, can be implemented.

Some exemplary methods disclosed herein comprise receiving historical healthcare claim data comprising at least one historical diagnosis code and at least one historical procedure code belonging to a first healthcare classification system (such as ICD-9); receiving a historical payment code (such as a DRG code) that is associated with the at least one historical diagnosis code and the at least one historical procedure code; determining a plurality of candidate diagnosis codes belonging to a second healthcare classification system (such as ICD-10), the candidate diagnosis codes being mapped to the at least one historical diagnosis code; determining a plurality of candidate procedure codes belonging to the second healthcare classification system, the candidate procedure codes being mapped to the at least one historical procedure code; determining a plurality of candidate payment codes that are based on permutations of the candidate diagnosis codes and the candidate procedure codes; and from among the candidate payment codes, selecting a most financially neutral candidate payment code with respect to the historical payment code.

Some of these methods can further comprise generating a plurality of permutations of the candidate diagnosis codes in combination with the candidate procedure codes, wherein determining a plurality of candidate payment codes comprises, for a given permutation from among the permutations, determining a respective candidate payment code for the given permutation. In some of these methods, generating a plurality of permutations of the candidate diagnosis codes in combination with the diagnosis codes can comprise weighting the permutations in favor of a principal code, such as skipping at least one permutation comprising a non-principal code when generating the permutations. The skipping can be throttled by a weighting factor.

Some methods can further comprise selecting one of the candidate diagnosis codes and one of the candidate procedure codes that together are associated with the selected candidate payment code. Some of these methods can further comprise generating a mapping rule that correlates an original permutation comprising the at least one historical diagnosis code and the at least one historical procedure code with a replacement permutation comprising the selected candidate diagnosis code and the selected candidate procedure code. Some of the these methods can further comprise generating a plurality of such mapping rules that correlate a plurality of original permutations comprising historical diagnosis codes and historical procedure codes with a plurality of respective replacement permutations comprising selected candidate diagnosis codes and selected candidate procedure codes, wherein the plurality of mapping rules minimize financial impact of migrating from the first healthcare classification system to the second healthcare classification system. Some of these methods can further comprise receiving subject healthcare claim data to be converted from the first healthcare classification system to the second healthcare classification system, the subject healthcare claim data comprising at least one subject permutation, the subject permutation comprising at least one subject diagnosis code associated with the first healthcare classification system and at least one subject procedure code associated with the first healthcare classification system; and applying the plurality of mapping rules to the at least one subject permutation to generate at least one replacement permutation, the replacement permutation comprising at least one replacement diagnosis code associated with the second healthcare classification system and at least one replacement procedure code associated with the second healthcare classification system. Some of these methods can further comprise generating replacement healthcare claim data that replaces the received subject healthcare claim data, the replacement healthcare claim data comprising the at least one replacement permutation, wherein a total payment amount associated with the received subject healthcare claim data is substantially similar to, or equal to, a total payment amount associated with the generated replacement healthcare claim data.

Some of the disclosed methods comprise determining the candidate diagnosis codes and the candidate procedure codes comprises applying a General Equivalency Mapping, which maps codes of the first healthcare classification system to codes of the second healthcare classification system that represent overlapping subject matter.

The first healthcare classification system can be one version of the International Classification of Diseases (ICD) and the second healthcare classification system can be another version of ICD.

In some of the disclosed methods, the at least one historical diagnosis code comprises an historical primary diagnosis code and one or more historical secondary diagnosis codes, and the at least one historical procedure code comprises an historical principal procedure code and one or more historical ancillary procedure codes; the plurality of candidate diagnosis codes comprise one or more candidate primary diagnosis codes that are mapped to the historical primary diagnosis code, and one or more candidate secondary diagnosis codes that are mapped to the one or more historical secondary diagnosis codes; and the plurality of candidate procedure codes comprise one or more candidate principal procedure codes that are mapped to the historical principal procedure code, and one or more candidate ancillary procedure codes that are mapped to the one or more historical ancillary procedure codes. In some of these methods, permutations that the plurality of candidate payment codes are based on comprise a subset of a set of possible permutations, each permutation in the set of the possible permutations comprising at least one candidate diagnosis code and at least one candidate procedure code, each permutation in the subset comprising at least one candidate primary diagnosis code or at least one candidate principal procedure code.

Some disclosed computing system comprise a processor and a memory, the memory storing computer-executable instructions that when executed cause the computing system to perform a method, the method comprising: receiving historical healthcare claim data comprising a plurality of historical healthcare codes associated with a first healthcare classification system, the plurality of historical healthcare codes representing diagnoses, procedures, or diagnoses and procedures relating to a patient, the plurality of historical healthcare codes being associated with a first total payment amount; determining a plurality of candidate healthcare codes associated with a second healthcare classification system, the candidate healthcare codes being mapped to the historical healthcare codes, wherein a plurality of different permutations of the candidate healthcare codes are associated with a plurality of respective second total payment amounts; selecting one of the plurality of permutations that is associated with a second total payment amount that is most similar to the first total payment amount associated with the historical healthcare codes of the received historical healthcare claim data; and generating a mapping rule that correlates the historical healthcare codes with the selected permutation of candidate healthcare codes.

In some cases, one or more computer readable media store computer-executable instructions that when executed cause a computing device to perform a method, the method comprising: receiving historical healthcare claim data based on a first healthcare classification system, the historical healthcare claim data comprising a first diagnosis code based on the first healthcare classification system, a first procedure code based on the first healthcare classification system, and a first Diagnosis-Related Group (DRG) code based on the first diagnosis code and the first procedure code; determining a set of second diagnosis codes based on a second healthcare classification system, the set of second diagnosis codes being associated with the first diagnosis code, and a set of second procedure codes based on the second healthcare classification system, the set of second procedure codes being associated with the first procedure code; determining a set of second DRG codes that are based on permutations of the second diagnosis codes and the second procedure codes; determining a set of payment amount differences between payment amounts associated with the set of second DRG codes and a payment amount associated with the first DRG code; determining a smallest payment amount difference of the set of payment amount differences, selecting one of the set of second DRG codes that corresponds to the smallest payment amount difference, and selecting one of the set of second diagnosis codes and one of the set of second procedure codes that together are associated with the selected second DRG codes; and generating a rule that correlates a first permutation comprising the first diagnosis code and the first procedure code with a second permutation comprising the selected second diagnosis code and the selected second procedure code.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an exemplary system implementing the technologies described herein.

FIG. 2 is a flowchart of an exemplary method of implementing the technologies described herein.

FIG. 3 shows exemplary historical healthcare claim data including exemplary codes from a first healthcare classification system.

FIG. 4 shows exemplary historical healthcare claim data including exemplary codes from a first healthcare classification system.

FIG. 5 shows screen shots of exemplary user interfaces for implementing the technologies described herein.

FIG. 6 is a diagram showing exemplary relationships between codes of a first healthcare classification system and a second healthcare classification system.

FIG. 7 is a block diagram of an exemplary system implementing the technologies described herein.

FIG. 8 is a flowchart of an exemplary method of implementing the technologies described herein.

FIG. 9 is a block diagram of an exemplary computing environment suitable for implementing any of the technologies described herein.

### DETAILED DESCRIPTION

The following description is directed to methods for determining financially neutral healthcare coding changes related to changes in healthcare classification systems. The various techniques and solutions can be used in combination or independently. Different embodiments can implement one or more of the described techniques and solutions.

As used in this application, the singular forms “a,” “an,” and “the” include the plural forms unless the context clearly dictates otherwise. The phrase “and/or” means “and”, “or” and both “and” and “or”. The term “includes” means “comprises.” The term “coupled” generally means mechanically, electrically, magnetically and/or chemically coupled or linked and does not exclude the presence of intermediate elements between the coupled or associated items absent specific contrary language.

### Example 1

### Exemplary System Employing Technologies

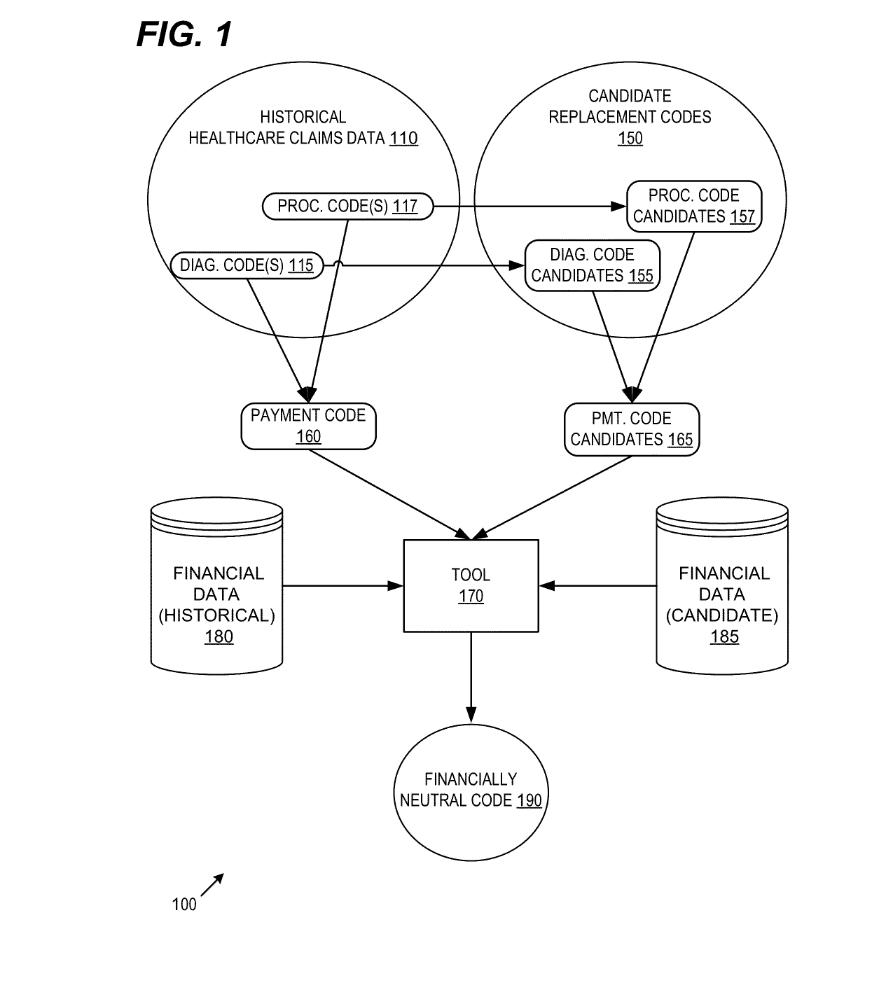

FIG. 1 is a block diagram of an exemplary system 100 implementing the technologies described herein. In the system 100, a tool 170 can receive historical payment codes 160, and candidate payment codes 165, and can output and/or determine at least one financially neutral code 190 associated with the at least one of the candidate payment codes 165 that is most financially neutral with, or similar to, the historical payment code 160.

The historical payment code 160 can be based on historical healthcare claims data 110, which can comprise one or more historical procedure codes 115 and/or one or more historical diagnosis codes 117. In some implementations, the historical payment code 160 can already be present in the historical healthcare claims data 110.

The candidate payment codes 165 can be based on one or more candidate replacement codes 150. The candidate replacement codes 150 can include one or more candidate diagnosis codes 155 and/or one or more candidate procedure codes 157.

The candidate diagnosis codes 155 can represent overlapping subject matter with and/or be mapped to respective historical diagnosis codes 115. Similarly, the candidate procedure codes 157 can represent overlapping subject matter with and/or be mapped to respective historical procedure codes 117.

In determining the financially neutral code 190, the tool 170 can compare historical financial data 180 related to the historical payment code 160 with candidate financial data 185 related to the candidate payment codes. This financial data 180, 185 can be stored in a database or received from another source.

In some embodiments, the tool 170 can draw additional information from and/or store information in other databases. Such additional information can include the historical claim data 110, the candidate replacement codes 150, payment codes and/or means for calculating the payment codes, and/or mappings between the codes of the different healthcare classification systems. Any of this information can optionally also be received by the tool 170 from other sources, such as input from a human user.

In practice, the systems shown herein, such as system 100 can be more complicated, with additional functionality, more complex operations, and the like.

Although the tool 170 is shown as accepting the payment code 160 and the payment code candidates 165 as input, the tool 170 can be of different scope. For example, the tool 170 can accept the historical healthcare claims data 110 as input, determine the candidate replacement codes 150, and determine payment code candidates 165 within the tool 170.

In any of the examples herein, the tool 170 and its inputs, outputs, and other information can be stored in one or more computer-readable storage media and can be implemented at least in part by a computing system.

### Example 2

### Exemplary Method of Implementing Technologies

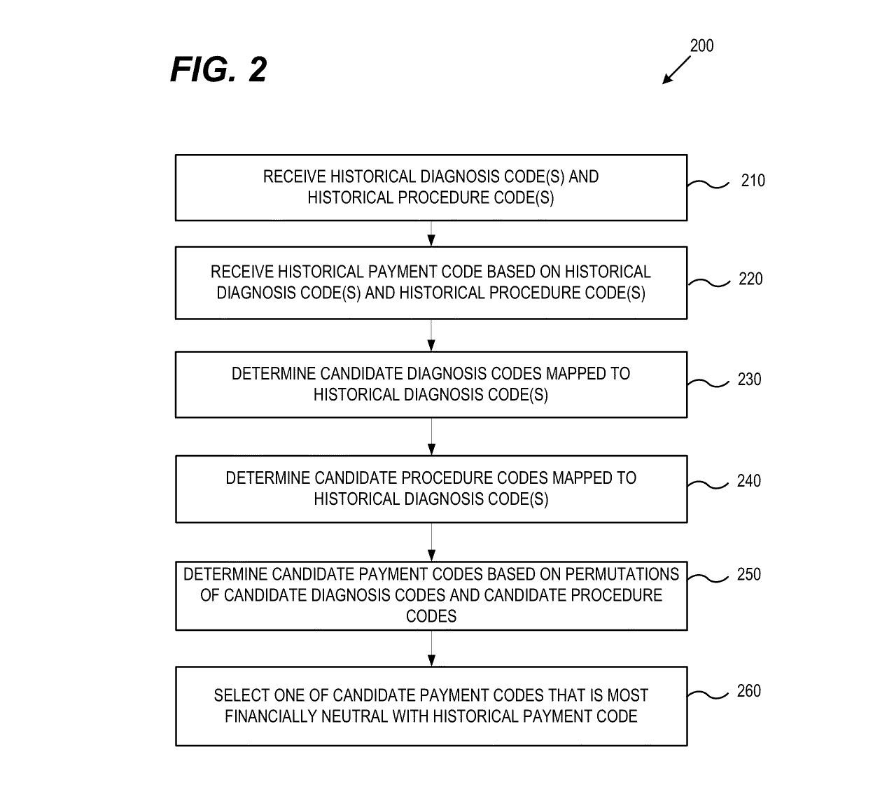

FIG. 2 is a flowchart of an exemplary method 200 for of implementing technologies described herein. The method 200 can be implemented, for example, using the system 100 and/or other systems described herein. The technologies described herein can be generic to the specifics of operating systems or hardware and can be applied in any variety of environments to take advantage of the described features.

At 210, one or more historical diagnosis codes 115 and/or one or more historical procedure codes 117 can be received. The historical codes 115, 117 can be from, or associated with, a first healthcare classification system, such as ICD-9. These codes can originate from historical healthcare claim data for one or more patients, which can be stored in healthcare records. The diagnosis and procedure codes can represent healthcare services rendered to patients. For example, the diagnosis codes 115 can represent one or more diagnoses determined by healthcare providers related to patient health issues, and the procedure codes 117 can represent one or more procedures provided to the patients related to the diagnoses. Together, the diagnosis codes and procedure codes can represent the amount of healthcare services provided for patients.

At 220, the historical payment code 160 can be received and/or determined. In some embodiments, the historical payment code 160 can be a DRG code, such as from an MS-DRG coding system. The historical payment code 160 can be based on the one or more historical diagnosis codes 115 and the one or more historical procedure codes 117.

In some embodiments, the historical payment code 160 can be determined prior to its being received, and then it can be received. For example, the historical payment code 160 can be determined by a healthcare provided or health insurance provider and included in a healthcare claim along with the diagnosis code 115 and the procedure code 117. In other embodiments, the method can comprise determining the historical payment code 160 base on the historical diagnosis and procedure codes 115, 117. A tool called a grouper, for example, can be used to determine payment codes based on diagnosis and procedure codes.

At 230, one or more candidate diagnosis codes 155 can be determined, and at 240, one or more candidate procedure codes 157 can be determined. The candidate diagnosis and procedure codes 155, 157 can be from, or associated with, a second (typically newer) healthcare classification system, such as ICD-10. The candidate diagnosis codes 155 can be mapped to the historical diagnosis code 115 and the candidate procedure codes 157 can be mapped to the historical procedure code 117. Code mappings between different classification systems are discussed in more detail in Example 13 below.

At 250, one or more candidate payment codes 185 can be determined based on permutations of the candidate diagnosis codes 155 and the candidate procedure codes 157.

At 260, one of the candidate payment codes 185 can be selected. The selected candidate payment code can be the most financially neutral candidate payment code, with respect to the historical payment code 160, from among all the candidate payment codes 185.

### Example 3

### Exemplary Historical Claim Data

The codes of historical claim data 110 can be from, or associated with, a first healthcare classification system, such as a version of the International Classification of Diseases and Related Health Problems (commonly known as ICD). The ICD is a medical classification system that provides codes to classify diseases and a wide variety of signs, symptoms, abnormal findings, complaints, social circumstances, and external causes of injury or disease. Under ICD, every health condition can be assigned to a unique category and given a code, up to seven characters long, either numeric or alphanumeric. Such categories can include a set of similar diseases. The ICD is published by the World Health Organization (WHO) and used worldwide for morbidity and mortality statistics, reimbursement systems, and automated decision support in medicine. This system is designed to promote international comparability in the collection, processing, classification, and presentation of these statistics. The ICD is a core classification of the WHO Family of International Classifications (WHO-FIC).

The ICD is revised periodically and the version in common use in the healthcare industry often changes over time. Other version of the ICD include ICD-6, ICD-9, ICD-9-CM (International Classification of Diseases, Clinical Modification), ICD-10-CM, ICD-10, ICD-10-CA (Canadian version of ICD-10), and ICD-11. The first healthcare classification system described herein can comprise any of these versions of the ICD.

The first healthcare classification system described herein can also comprise other classification systems, such as the International Classification of Functioning, Disability and Health (ICF), the International Classification of Health Interventions (ICHI), the International Classification of Primary Care (ICPC), the International Classification of External Causes of Injury (ICECI), the International Classification of Nursing Practice (ICNP), and the like.

### Example 4

### Exemplary Diagnosis Codes

The diagnosis codes 115 can comprise a primary diagnosis code and optionally one or more secondary diagnosis codes. The primary diagnosis code can represent the condition that is most related to a patient's current plan of care, or the condition that is chiefly responsible for occasioning the admission of a patient to the hospital for care. Since the primary diagnosis code represents the reason for the patient's stay, it may not necessarily be the diagnosis code which represents the greatest length of stay, the greatest consumption of hospital resources, or the most life-threatening condition.

Secondary diagnosis codes can represent all other conditions that coexisted at the time the plan of care was established, or which developed subsequently, or affect the treatment or care. The secondary diagnosis codes can represent not only conditions actively addressed in the patient's plan of care, but also any comorbidity affecting the patient's responsiveness to treatment and rehabilitative prognosis, even if the condition is not the focus of any health treatment itself.

Exemplary primary and secondary diagnosis codes can comprise a string of alphanumeric characters, typically 3-7 characters long. An exemplary ICD-9 diagnosis code is “73314,” which represents a diagnosis of a pathological fracture at the neck of the femur. An exemplary ICD-10 diagnosis code is “M84459A,” which represents a diagnosis of an initial encounter of a pathological fracture of the hip. These diagnosis codes can be either primary diagnosis codes or secondary diagnosis codes, depending on the context of the patient's condition and plan of care.

### Example 5

### Exemplary Procedure Codes

The procedure codes 117 can comprise a principal procedure code and optionally one or more ancillary procedure codes. The principal procedure code can represent the principal procedure that was performed during a hospitalization or other patient visit. The principal procedure can be the procedure performed for definitive treatment rather than diagnostic or exploratory purposes, or which is necessary to take care of a complication.

Ancillary procedure codes can represent all other procedures that were performed related to the patient, which can include diagnostic and exploratory procedures.

Exemplary principal and ancillary procedure codes can comprise a string of alphanumeric characters, typically 3-7 characters long. An exemplary ICD-9 procedure code is “8152,” which represent a partial hip replacement. An exemplary ICD-10 procedure code is “0QR43JZ,” which represents a percutaneous replacement of the right acetabulum with a synthetic substitute. These procedure codes can be either principal procedure codes or ancillary procedure codes, depending on the context of the patient's condition and treatment.

### Example 6

### Exemplary Candidate Codes

When converting claim data from a first classification system to a second classification system, a plurality of candidate codes can be determined that are mapped to or related to the historical codes of the first classification system. The candidate codes can be from, or associated with, the second healthcare classification system. The second healthcare classification system can comprise any of the classification systems that the first healthcare classification system can comprise, as described above in Example 3. The second healthcare classification system is typically a newer system than the first healthcare classification system that is associated with historical codes. In a common example, the first healthcare classification comprises ICD-9 and the second healthcare classification comprises ICD-10. The second system can have a greater granularity than the first system. The second system can also comprise more diagnosis and/or more procedure codes than the first system. For example, ICD-9 includes approximately 17,000 codes, while ICD-10 includes approximately 165,000 codes, providing a much higher level of detail or granularity.

### Example 7

### Exemplary Payment Codes

A payment code can be a Diagnosis-Related Group (DRG) code or other healthcare cost-related code. “Payment codes” and “DRG codes” described herein can comprise codes associated with Medicare-related coding systems, such as CMS-DRG and MS-DRG coding systems from the Centers for Medicare and Medicaid Services. In particular embodiments, the most recent versions (e.g., versions 25, 26, 27 or 28) of the MS-DRG coding system can be used. Each DRG code can be based on several different diagnosis codes and several different procedure codes. For example, some DRG codes can be based on up to 16 different diagnosis codes and/or up to 16 different procedure codes. An exemplary DRG code can comprise a numeric string of 3 or 4 characters. A DRG coding system can comprise approximately 500-1000 different DRG codes. In other embodiments, the “payment codes” can comprise codes of other healthcare cost-related coding systems, which can be based on any number of diagnosis and procedure codes. Both the historical payment codes and the candidate payment codes can be from the same version of a coding system.

Based on the diagnosis and procedure codes (and sometimes other data such as age and gender), a payment coding system can classify healthcare case types into groups that are expected to have similar hospital resource use. The payment codes can be related to the “products” that the patient received from the hospital. In some cases, a grouper tool, typically generated and provided by Medicare or another reimburser, can be used to calculate the desired payment code based on the given diagnosis and procedure codes, and optionally with other data such as age and gender or the patient.

### Example 8

### Exemplary Financial Data

In any of the examples herein, financial data can include how much is paid or due to be paid (e.g., a dollar amount) for a claim having a particular payment code. For example, payment codes can be used by healthcare and insurance providers to indicate how much money they should be reimbursed for a given healthcare claim. Medicare is often the entity that reimburses the provider based on the payment code. Patients within each payment code category can be similar clinically and can be expected to use or consume the same or similar level of hospital resources, and thus the healthcare claims of those patients can be expected to receive the same or similar level of monetary reimbursement.

### Example 9

### Exemplary Mapping

In any of the examples herein, mapping can indicate a relationship between codes. For example, one-to-one, one-to-many, and many-to-many mappings can be implemented. Although a code is sometimes described as “mapped to” another code, it does not necessarily mean that the first code mentioned was mapped to the second code. Instead, the second code may have been provided, and the first code determined via a mapping.

### Example 10

### Exemplary Claim-Based and Record-Based Processing

In any of the examples herein, processing can be performed on a claim-by-claim and/or record-by-record basis. For example, a single healthcare claim can include the historical diagnosis and procedure codes 115, 117 and the historical payment code 160, all relating to a particular healthcare visit by a patient. During that visit, the patient may have been diagnosed with one or more diagnoses and one or procedure may have been performed for the patient. From that healthcare visit, a single healthcare claim may have been generated that includes the codes 115, 117, which are from a first healthcare classification system, and the payment code 160. The method 200 can be performed on that healthcare claim data to determine candidate codes 155, 157 from a second healthcare classification system that are mapped to the codes 115, 117, and to select a candidate payment code based on the candidate codes 155, 157 that is the most financially neutral relative to the historical payment code 160 in the claim data.

This process can also be used for healthcare claims that cover multiple healthcare events. For example, a healthcare claim can include the historical diagnosis codes 115 and/or the historical procedure codes 117 related to plural healthcare events, such as first patient visit to a doctor to diagnose and treat a broken leg, and a later patient visit to have a prescription refilled. In some of these examples, only a single historical payment code 160 can be included in the healthcare claim based on the services provided during both patient visits. In such an example, the method 200 can be used to convert the codes of the healthcare claim from an older healthcare classification system, such as ICD-9, to the codes of a newer system, such as ICD-10. For both visits, a candidate payment code can be selected that is most financially neutral with the historical payment code 160. Similarly, the method 200 can be used for healthcare records that include multiple healthcare claims.

In some embodiments, the method 200 can be iterated claim-by-claim for plural healthcare claims. Furthermore, the method can be performed record-by-record for plural records by performing the method for the claims of a first record, then performing the method for the claims of a second record, and so on.

### Example 11

### Exemplary Financially Neutral Candidate Payment Code

In 260 of method 200, selecting a most financially neutral candidate payment code can comprise comparing a first payment factor associated with the historical payment code with one or more second payment factors associated with respective candidate payment codes, and from among the candidate payment codes, selecting a candidate payment code that has an associated respective second payment factor that is most similar to (e.g., closest in amount or value to, or having a smallest payment factor difference with) the first payment factor. The term “payment factor” can mean a payment amount (such as a dollar amount), a payment weight associated with a payment amount (such as a DRG weight), or a payment factor from which a payment amount can be calculated. Payment factors can be used with other healthcare factors, such as length of stay, geographical location, etc., to determine a dollar amount. In most cases, these other healthcare factors remain unchanged when converting from one healthcare classification system to another, so financial neutrality can be determined based only on the payment factor. Preferably, the selected candidate payment code is associated with a payment factor that is equal to the payment factor associated with the historical payment code. The selected candidate payment code can be referred to as a financially neutral candidate payment code.

In some examples, the method 200 can further comprise flagging the received historical healthcare claim data for manual analysis in certain cases. For example, the received claim data can be flagged for manual review in response to determining that none of the candidate payment codes has an associated second payment amount that is equal to the first payment amount. In such a case, a manual reviewer can select one of the candidate payment codes that results in a desired level of financial neutrality relative to the historical payment code.

### Example 12

### Exemplary Healthcare Claim Data

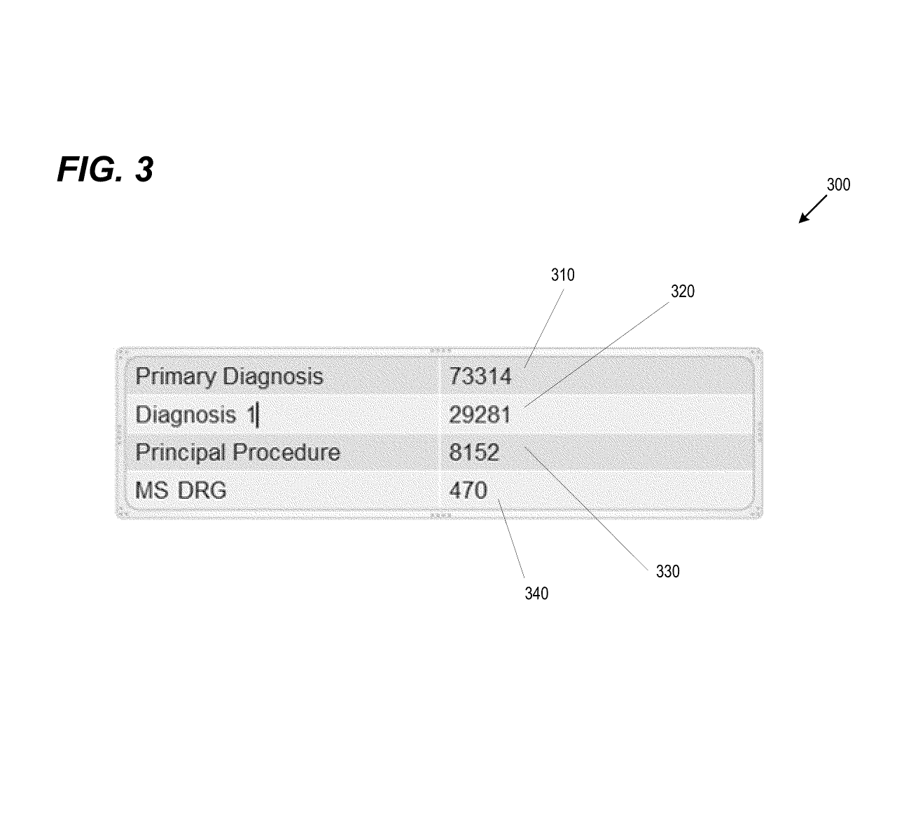

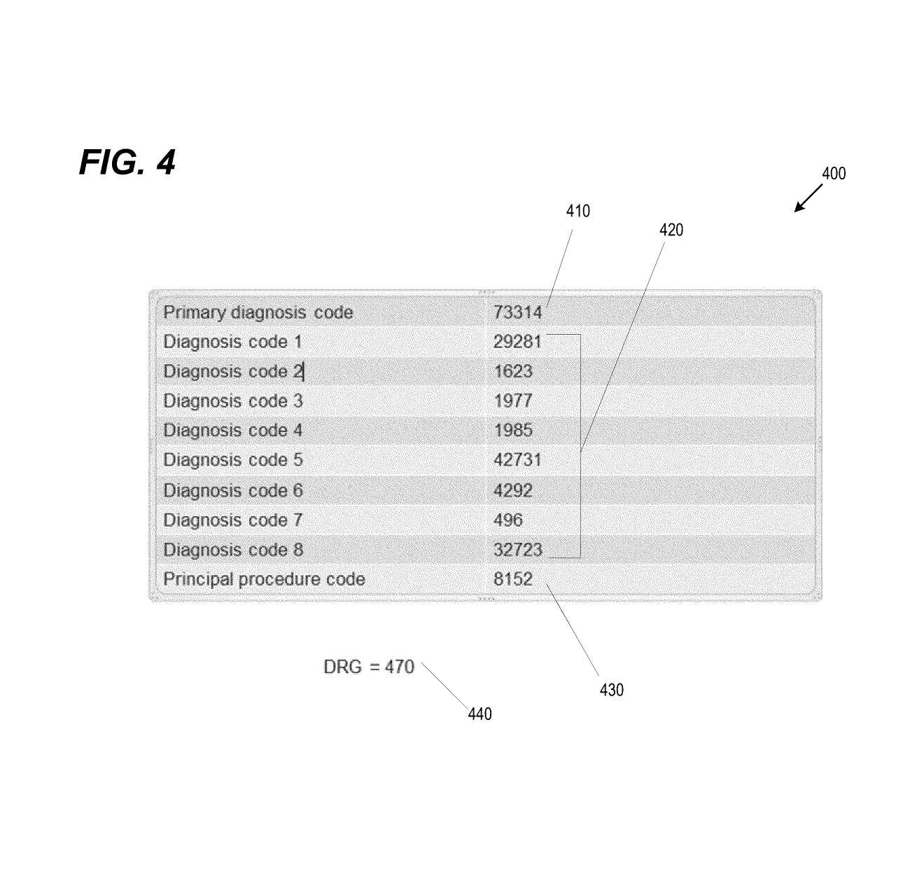

FIGS. 3 and 4 show examples of the historical healthcare claim data 110 for respective single healthcare claims. FIG. 3 shows exemplary historical claim data 300, which comprises exemplary historical diagnosis codes 310 and 320, an exemplary historical procedure code 330, and an exemplary historical payment code 340 for a healthcare claim. The diagnosis code 310 is a primary diagnosis code and the diagnosis code 320 is a secondary diagnosis code. The primary diagnosis code 310 can indicate the most significant, or primary, diagnosis that was determined for a patient during a healthcare visit, and the secondary diagnosis code 320 can indicate a less important, or secondary, diagnosis that was also determined for the same patient. For example, the primary diagnosis code 310 can indicate a broken leg, while the secondary diagnosis cade 320 can indicate a fever caused by the broken leg.

Similarly, the historical procedure code 330 indicates principal procedure performed on the patient in relation to one or more of the diagnoses. In FIG. 3, only one procedure code is shown, and no ancillary procedure codes are included.

A historical payment code 340 is also included in the claim data 300. The payment code can indicate a payment amount associated with the healthcare claim, and can be based on the overall cost of providing the diagnoses indicated by 310 and 320 and the procedure indicated by 340. In this example, the codes 310, 320 and 330 care codes from ICD-9 and the payment code 340 is a DRG code based on version 27 of an MS-DRG coding system. The DRG code 340 can indicate to an insurance company or other entity the payment amount that is to be paid in response to the healthcare claim.

FIG. 4 shows exemplary historical claim data 400, which comprises a primary diagnosis code 410, eight secondary diagnosis codes 420, a principal procedure code 430, and a payment code 440 for a healthcare claim. This example illustrates that one healthcare claim can include many different diagnosis and/or many different procedures. Although not illustrated in FIGS. 3 and 4, one claim can include several ancillary procedure codes in addition to the principal procedure code 430. All of these diagnoses and procedures can form the basis of a single payment code 440, which can represents the overall cost of providing the diagnoses and procedures, and thus the amount of payment to be received.

Healthcare claims data for a claim can be associated together in a record for purposes of storage, analysis, and other processing.

### Example 13

### Exemplary Mappings Between Healthcare Classification Systems

At 230 and 240 of the method 200, the candidate diagnoses codes are mapped to the historical diagnoses codes and the candidate procedure codes are mapped to the historical procedure codes. In some embodiments, determining the candidate diagnosis codes and the candidate procedure codes can comprise using or applying a General Equivalency Mapping (GEM), which maps codes of the first healthcare classification system to codes of the second healthcare classification system that represent overlapping subject matter. One exemplary GEM is available from the Centers for Medicare and Medicaid Services (CMS), a nodal agency for healthcare in the United States. Other customize GEMs can also be used. In such a GEM, there can be many different types of relationships between the codes of the two different classification systems. For convenience, the following examples are described with “A” being the first healthcare classification system and “B” being the second healthcare classification system.

In some instances, a given A code can be mapped one-to-one with a single B code. In this case, at 230/240 of the method 200, determining a candidate code mapped to the historical code can comprise selecting the single B code that is mapped one-to-one with the given A code.

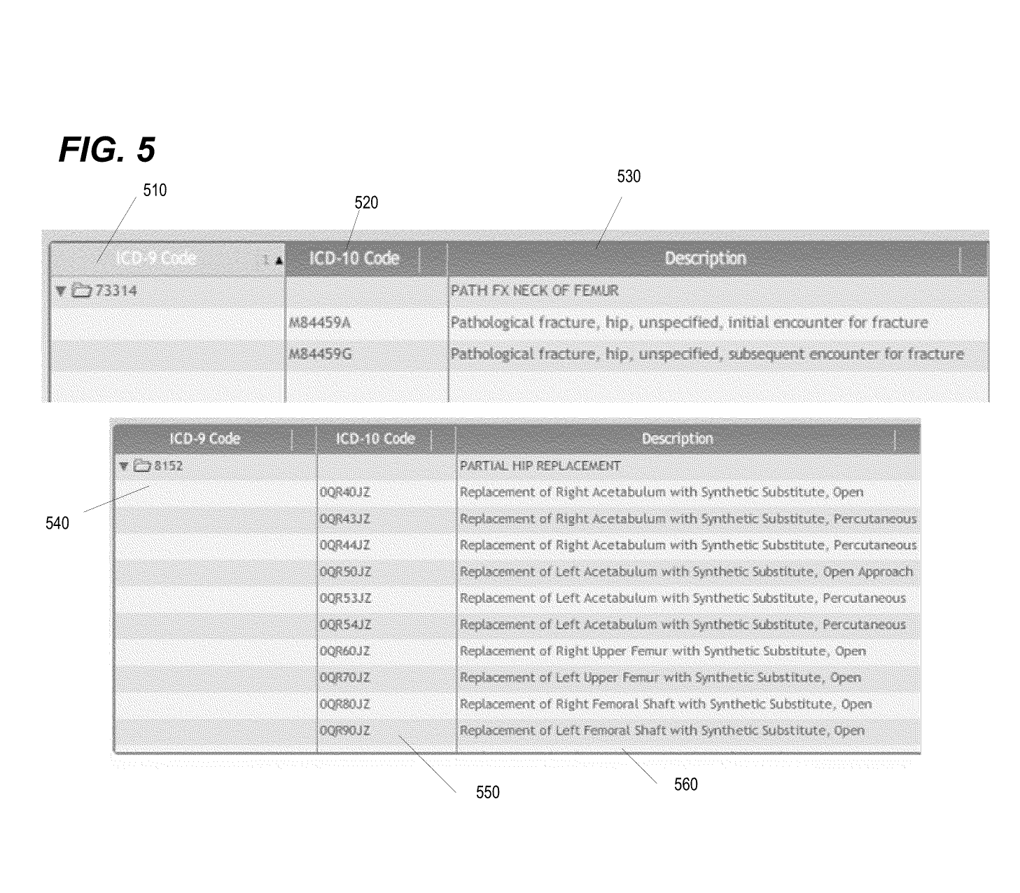

In other instances, a given A code can be mapped to plural alternative B codes. FIG. 5 shows such an example wherein A is ICD-9 and B is ICD-10. 510 is a historical diagnosis code “73314” from ICD-9. At 520 are two candidate diagnosis codes “M84459A” and “M84459G” from ICD-10 that are mapped to the ICD-9 code “73314”. At 530, the ICD-9 diagnosis code “73314” is described as a fracture of the neck of the femur. The two ICD-10 diagnosis codes, however, differentiate between an initial encounter of the fracture and a subsequent encounter of the fracture. So both of the candidate ICD-10 diagnosis codes share overlapping subject matter with the historical ICD-9 diagnosis code, but the scope of the codes is slightly different. Similarly, the historical ICD-9 procedure code at 540 represents a “partial hip replacement,” and is mapped to 10 different candidate ICD-10 procedure codes at 550, such as “replacement of right acetabulum with synthetic substitute, open,” that represent overlapping subject matter but have a slightly different, typically narrower, scope, as shown in the descriptions 560. In such a case where a given A code is mapped to plural alternative B codes, at 230/240 of the method 200, determining a candidate code mapped to the historical code can comprise selecting the plural B codes (e.g., all of them) that are mapped to the given A code.

An A code being mapped to a B code can represent partial or complete overlap of subject matter. In some instances, the two codes can represent the exact same concept, such as a broken femur. In other instances, however, two codes mapped together can only partially overlap or one can be a subset of the other. For example, the B code can represent only a subset or species of the concept represented by the A code to which it is mapped. The opposite can also be true, where the A code represents a subset or species of the concept represented by the B code to which it is mapped. In some cases, the A code can be mapped to an identical B code.

In some examples, an A code may be mapped to a combination of plural B codes. For example, a given A code may represent a broken femur with a fever, and the A code can be mapped to a combination of a first B code for a broken femur and a second B code for a fever. In such cases, at 230/240 of the method 200, determining candidate codes mapped to the historical code can comprise selecting both B codes that are mapped in combination to the given A code.

In some instances, alternative plural A codes can be mapped to a single B code, or a combination of A codes can be mapped to a single B code. In these instances, if a given historical code is one of these plural A codes, then the given historical code can be mapped to the single candidate B code.

In some examples, an A code may not be mapped to any codes in B. Such instances can be flagged for manual review and action.

In some examples, one or more of the A codes can be the exact same code as one or more of the B codes. Thus, mappings between A and B can include maps between a given A code and an identical B code. In other cases, a given A code can be different than a B code to which it is mapped, but the given A code can nevertheless represent the exact same subject matter as the B code. In still other cases, a given A code can be mapped to an identical B code, but the two codes can represent different subject matter.

In any of the examples herein, a mapping arrangement can be accomplished by storing an association between B code(s) and A code(s) in a data structure and then determining the mapped code from an input code, which includes consulting the data structure to determine the mapped code from the input code.

### Example 14

### Exemplary Permutations

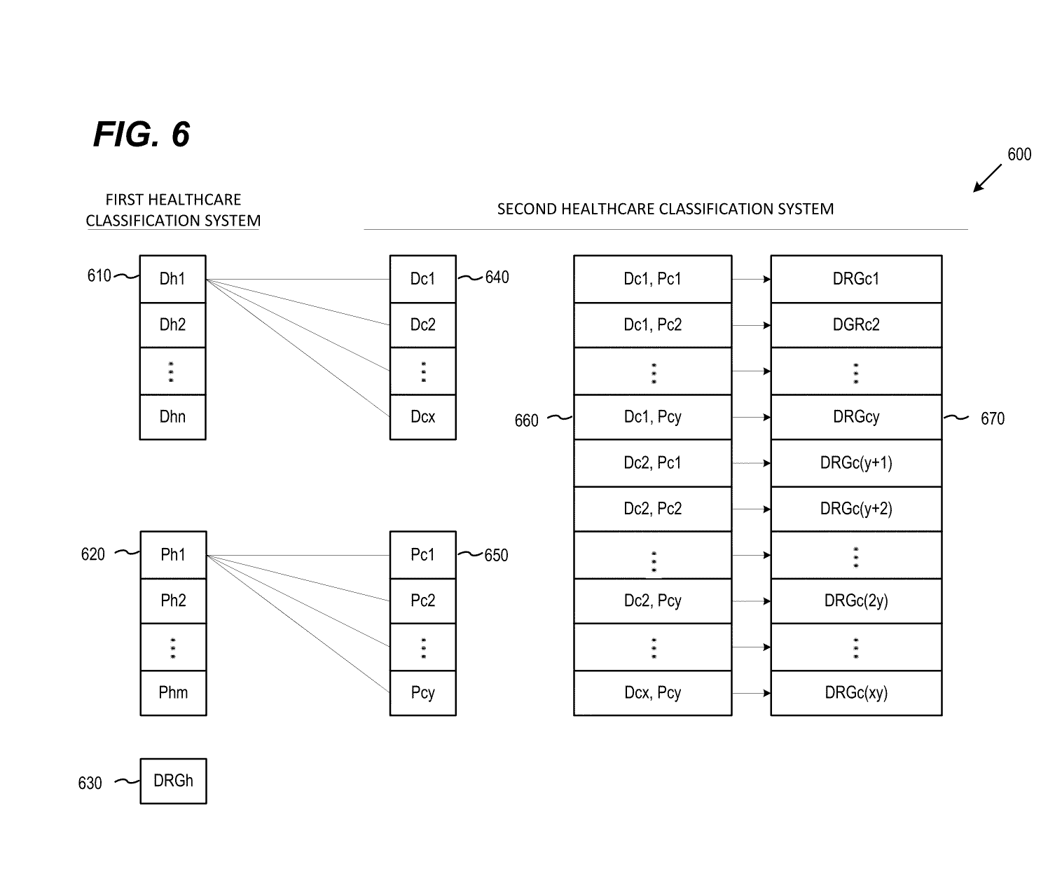

FIG. 6 shows exemplary relationships 600 between codes of a first healthcare classification system, codes of a second healthcare classification system, and payment codes.

Block 610 comprises n historical diagnosis codes, labeled Dh1 through Dhn. Block 620 comprises m historical procedure codes, labeled Ph1 through Phm. These blocks can represent the one or more historical diagnosis codes 115 and/or one or more historical procedure codes 117 received at 210 of method 200.

Block 630 comprises a historical payment code, labeled DRGh, that is based on the n historical diagnoses codes and the m historical procedure codes. This block can represent the historical payment code 160 received at 220 of method 200. The historical codes in blocks 610 and 620 can be from a first healthcare classification system, such as ICD-9. In one example, the historical codes 610, 620 and 630 can be received from a single historical healthcare claim or healthcare record, and can represent healthcare services provided to a patient and a payment amount associated with those services.

Each of the n historical diagnosis codes in block 610 can be mapped to one or more candidate diagnosis codes of a second healthcare classification system, as discussed in Example 13. For example, the historical diagnosis code Dh1 in block 610 can be mapped to the x candidate diagnosis codes Dc1 through Dcx in block 640. Similarly, Dh2 through Dhn can also be mapped to one or more candidate diagnosis codes, although these mappings are not shown in FIG. 6 for clarity. Block 640 can represent the one or more candidate diagnosis codes 155 determined at 230 of method 200.

Likewise, each of the m historical procedure codes in block 620 can be mapped to one or more candidate procedure codes of a second healthcare classification system, as discussed in Example 13. For example, the historical procedure code Ph1 in block 620 can be mapped to the y candidate procedure codes Pc1 through Pcy in block 650. Similarly, Ph2 through Phm can also be mapped to one or more candidate procedure codes, although these mappings are not shown in FIG. 5 for clarity. Block 650 can represent the one or more candidate procedure codes 157 determined at 240 of method 200.

In one example, Dh1 can represent a historical primary diagnosis code and Dh2 through Dhn can represent historical secondary diagnosis codes. Similarly, Ph1 can represent a historical principal procedure code and Ph2 through Phm can represent historical ancillary procedure codes. Where Dh1 represents a historical primary diagnosis code, Dc1 through Dcx can represent candidate primary diagnosis codes. Similarly, where Ph1 represents a historical principal procedure code, Pc1 through Pcy can represent candidate principal procedure codes.

Block 660 comprises a plurality of permutations comprising one of the x candidate diagnosis codes of block 640 in combination with one of the y candidate procedure codes of block 650. The number of these permutations can equal x times y. However, these permutations in block 660 only represent candidate codes mapped to Dh1 and Ph1. Many additional permutations can be determined based on the candidate codes mapped to all n historical diagnosis codes and m historical procedure codes, those these additional permutations are not shown in FIG. 6 for clarity. Block 660 can represent the one or more candidate payment codes 185 determined in 250 of method 200.

Block 670 comprises a plurality of candidate payments codes that are based on the permutations in block 660. In some examples, each permutation in block 660 can be associated with a different payment code in block 670. In other examples, two or more of the payment codes in block 670 can be the same. Note that the candidate payment codes in block 670 are based on the Dh1 and Ph1 only. Many more candidate payment codes can be determined that are based on one or more of Dh2 through Dhn and/or Ph2 through Phm. Block 670 can represent the plurality of candidate payment codes determined at 260 of method 200.

As in 270 of method 200, the candidate payment codes in block 670 can be compared to the historical payment code in block 630, and one of the candidate payment codes that is most financially neutral with the historical payment code can be selected.

Referring again to Example 13, in cases where all of the B codes that are mapped to a given A code represent equivalent healthcare services, all of the B codes mapped to the given A code can be associated with the same payment amount. In such cases, all of the B codes mapped to the given A code can result in the same candidate payment code. In other words, in these cases, it does not matter which candidate B code is selected to replace the given A code because all of the B codes result in financial equivalence. Thus, when it is determined that all of the B codes associated with a given A code are financially equivalent, one or more of the different B codes in the set of candidate diagnosis or procedure codes can be omitted, thus the number of candidate permutations and candidate payment codes generated based on the given A code can be reduced.

### Example 15

### Weighting of Permutations

When two or more historical diagnosis codes and/or two or more historical procedure code are received, for example, the number of permutations of candidate diagnosis and procedure codes to be generated can be undesirably large. Similarly, the number of candidate payment codes associated with the permutations can be large. The time and/or resources need to generate the permutations and candidate payment codes can be undesirable. In some cases, it can be desirable to only determine a portion of these permutations and candidate payment codes, such as to save time and/or resources. Such an approach can be particularly useful when a user is navigating through various “what if” scenarios, which can be delayed by re-calculation of numerous sets of permutations in real time.

In some cases, only those permutations relating to certain of the historical codes can be determined. The determined permutations can be weighted in favor of the primary diagnosis code and the principal procedure code, collectively referred to as principal codes, as the principal codes often have a more significant impact on the payment codes. For example, in 250 of method 200, only those permutations that are based on candidate diagnosis and procedure codes mapped to either the historical primary diagnosis code or the principal procedure code can be determined. In other examples, only those permutations that are based on candidate diagnosis and procedure codes mapped to both the historical primary diagnosis code and the principal procedure code can be determined. In other examples, only those permutations that are based on candidate diagnosis codes mapped to the historical primary diagnosis can be determined. In other examples, only those permutations that are based on candidate procedure codes mapped to the historical principal procedure code can be determined. In other examples, any other subset of all possible permutations and candidate payment codes can be determined in order to expedite acts 250 and 260 of method 200.

In some examples, weighting the permutations in favor of the principal codes can comprise skipping at least one permutation comprising a non-principal code when generating the permutations. In some of these examples such skipping can be throttled by at least one weighting factor. For example, the weighting factor can indicate that more of the non-principal codes can be skipped while uniformly representing the principal codes (e.g., not skipping principal codes). Adjusting the weighting factor (e.g., increasing or decreasing it) can result in skipping additional non-principal codes, resulting in fewer resources consumed.

The weighting factor can be adjusted via configuration. For example, a user can adjust the weighting factor via a user interface to control how many permutations are generated. Code or group-level weighting can also be supported. Thus, if a user determines that a particular code or group of codes has a large financial impact on the candidate payment codes, then that code or group of codes can individually be weighed greater that other codes.

In some of these examples, the candidate payment codes can be determined one at a time as each permutation is generated, and the candidate payment codes can be compared to the historical payment code before the next permutation is generated. When one of the candidate payment codes is found to be equal to or substantially similar to the historical payment code, the generation of additional permutations can stop, avoiding the time and resourced needed to generate the remainder of the possible permutations and candidate payment codes.

Rather than one at a time, the permutations and/or candidate payment codes can be determined in groups and the candidate payment codes can be compared to the historical payment code in groups.

### Example 16

### Exemplary System with Rule Generator

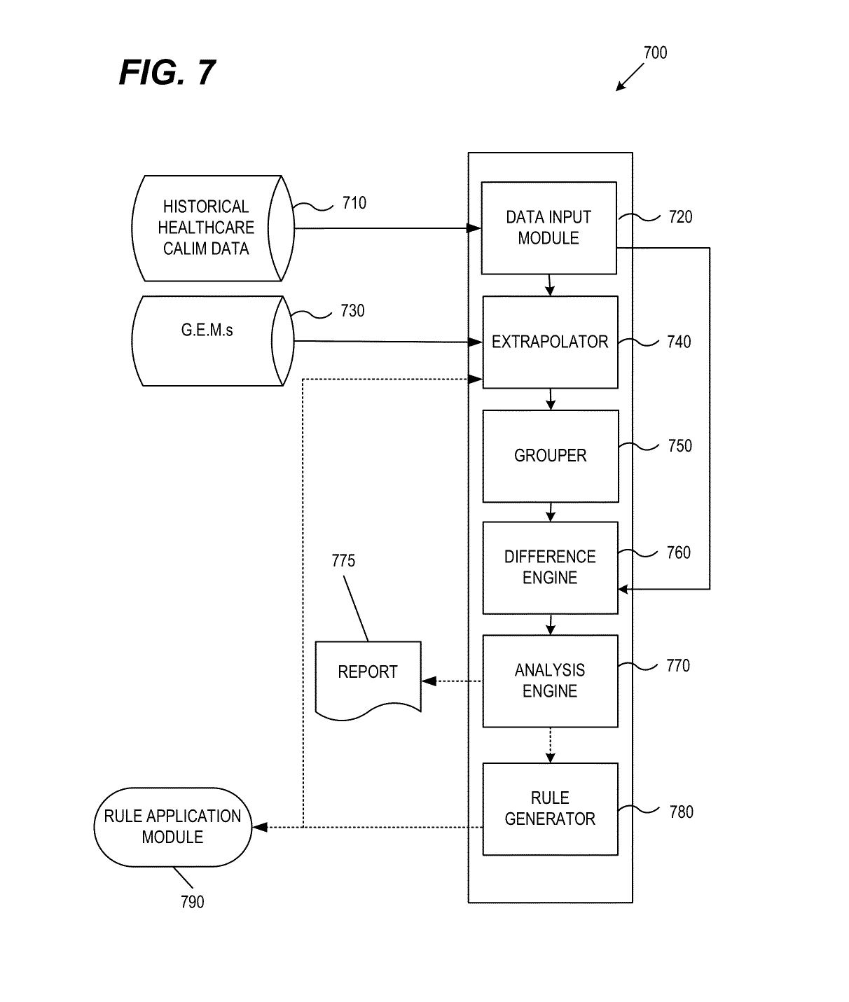

FIG. 7 is a block diagram of an exemplary system 700 for implementing technologies described herein. In the system 700, a data input module, or input adapter, 720 is operable to receive historical healthcare claim data from a database 710, which can include one or more historical diagnosis codes and one or more historical procedure codes. The data input module 720 can be operable to read claim data in plural different formats, such as a database format, an EDI format, a UB04 format, etc. Claim data can be received and read in iterative instances, e.g., for different lines of business of a client entity, state-by-state, by most common data type, by payment impact, etc.

An extrapolator 740 can be operable to receive historical diagnosis and procedure codes, as well as GEM data from a database 730. The extrapolator 740 can be operable to determine candidate codes that are mapped to the received historical codes and output the candidate codes to a grouper 750.

The grouper 750 can be operable to receive the candidate codes from the extrapolator 740 can determine candidate permutations of the candidate codes (such as based on weighing factors, GEM's and/or a rule application module) and can determine candidate payment codes based on the permutations of the candidate codes.

The candidate payment codes can be received by a difference engine 760, which can also receive a historical payment code from the data input module 720. The difference engine 760 can be operable to compare the input and post-grouper claim data based on any desired parameter, such as payment amounts. The difference engine 760 can compare the candidate payment codes to the historical payment code and determine differences in payment amounts associated with the candidate payment codes relative to a payment amount associated with the historical payment code. The difference engine 760 can identify codes, claims and/or records that are will be, or are likely to be, financially impacted by a migration from the first classification system to the second classification system. The difference engine 760 can “mark” the historical claim data to indicate whether or not converting to the second classification system may result in financially disparate payment codes.

An analysis engine 770 can receive the payment amount differences from the difference engine 760 and can be operable to select one of the payment amount differences that is substantially similar to, or equal to, the payment amount associated with the historical payment code, and/or select one of the candidate payment codes that is associated with a payment amount difference that is the smallest. The analysis engine 770 can identify the claim data that has been marked by the difference engine and analyze only that data for financial neutrality. The analysis engine can be operable to generate a report 775 that describes the candidate payment codes, the associated payment amounts, and/or the associated payment amount differences in related to the historical payment code and its associated payment amount.

Based on the one of the candidate payment codes selected by the analysis engine 770, a rule generator 780 can be operable to determine a candidate permutation of one or more candidate diagnosis and procedure codes upon which the selected payment code is based. For example, referring to FIG. 6, if the analysis engine selected payment code DRGc2 (in block 670), then the rule generator 780 can be operable to determine that the candidate permutation upon which DRGc2 is based comprises Dc1 and Pc2 (as shown in block 660 to the left of DRGc2).

Based on the candidate permutation determined by the rule generator 780, the rule generator 780 can be operable to generate a mapping rule that correlates the historical diagnosis and procedure codes received by the data input module with the candidate diagnosis and procedure codes of the candidate permutation determined by the rule generator 780. As a simple example, a mapping rule generated by the rule generator 780 can comprise “if historical diagnosis code equals Dh1 and historical procedure code equals Ph1, then select candidate diagnosis code Dc1 and candidate procedure code Pc2.” In some cases, the rule can allow for the selection of any one of a number of financially equivalent candidate codes.

A mapping rule generated by the rule generator 780 can be received by the extrapolator 740 and can be used in a later process to determine desirable candidate codes in response to received historical codes.

The mapping rule from rule generator 780 can also be received by a rule application module, or “crosswalk”, 790, which can be operable to implement the rule to convert subject claim data based on a first healthcare classification system into replacement claim data that is based on a different healthcare classification system, such as a newer system that is mandated by legislation or has become an industry standard.

### Example 17

### Exemplary Method of Generating Mapping Rules

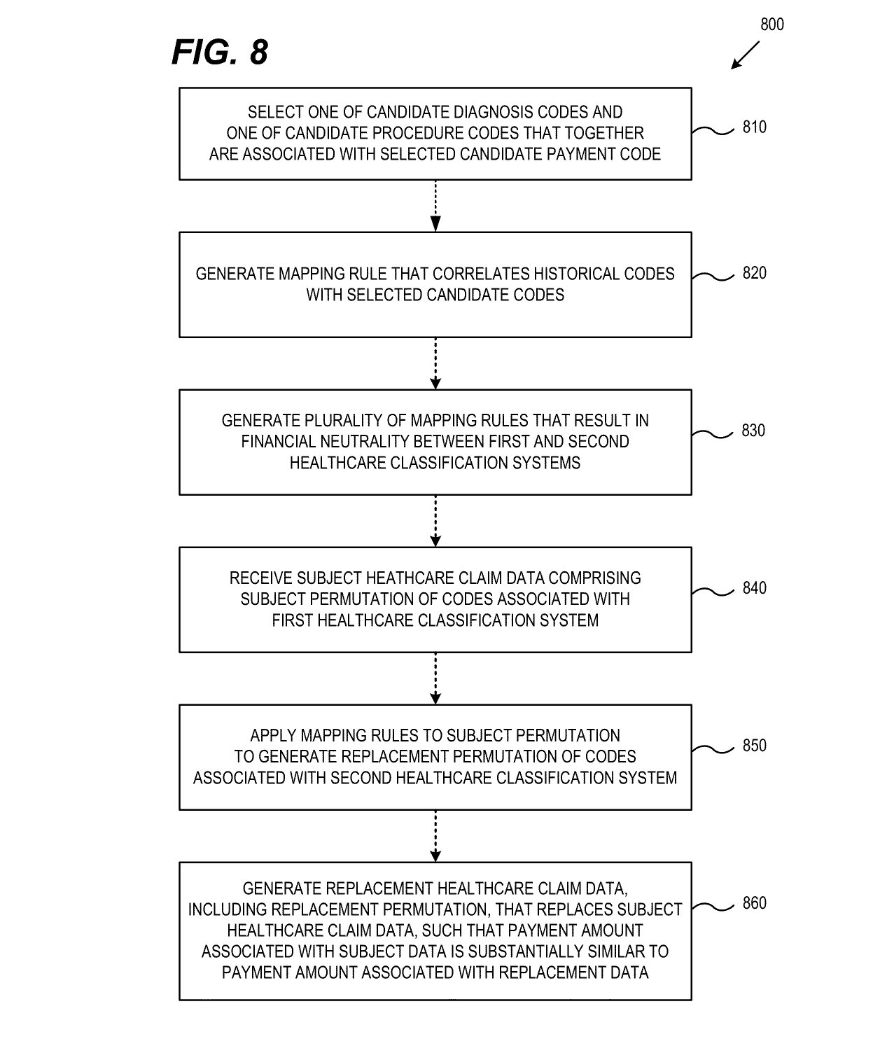

The methods discussed herein can further comprise additional acts for generating mapping rules and implementing those mapping rules to convert subject claim data into replacement claim data. FIG. 8 is a flowchart 800 of exemplary methods that can be performed to generate and apply mapping rules.

At 810, one of the candidate diagnosis codes and one of the candidate procedure codes, which together are associated with the selected candidate payment code, can be selected. These selected candidate codes can comprise the candidate permutation upon which the selected candidate payment code is based. In the case where it is determined that all of the candidate codes associated with a given historical code are financially equivalent, fewer than all of the different possible candidate codes may have been generated, and thus the number of candidate permutations and candidate payment codes generated based on the given A code may have been limited to simply the permutation generation process. In these cases, any one of the plurality of financially equivalent candidate codes that are associated with the selected candidate payment code can be selected at 810.

At 820, a mapping rule can be generated that correlates an original permutation, which comprises the at least one historical diagnosis code and the at least one historical procedure code, with a replacement permutation comprising the selected candidate diagnosis code and the selected candidate procedure code.

At 830, a plurality of such mapping rules can be generated that correlate a plurality of original permutations comprising historical diagnosis codes and historical procedure codes with a plurality of respective replacement permutations comprising selected candidate diagnosis codes and selected candidate procedure codes. The plurality of mapping rules, when implemented, can minimize financial impact of migrating from the first healthcare classification system to the second healthcare classification system. The plurality of original permutations can be associated with one or more different historical healthcare claims or records. The plurality of mapping rules can be generated by iteratively implementing the described methods on a claim-by-claim or record-by-record basis. The number of mapping rules generated can be sufficient such that enough subject claim data can be converted to replacement claim data to minimize the financial impact of a migration to a new healthcare classification system. For example, a statistically significant volume of historical claim data can be received and resulting mapping rules can be generated such that the overall financial impact can be limited, such as based on an averages and/or intersection analysis, or based on an overall total financial impact, or based on a probable financial impact. The term “minimize” means to reduce or lessen to some extent, and does not necessarily mean to reduce to the lowest possible financial impact.

Intersection analysis can be used mapping rules. For example, consider a hypothetical first record having a first original code that maps to two candidate codes D1 and D2 that both achieve equal financial neutrality. In another hypothetical record having the same original code in the same position (i.e., principal or secondary) but different other diagnosis and/or procedure codes, only D1 results in financial neutrality. In this case, a rule can be generated that prefers D1 over D2 as a replacement code in situations like the first record. This can make rules easier to maintain.

At 840, subject healthcare claim data can be received that is to be converted from the first healthcare classification system to the second healthcare classification system. The subject healthcare claim data can comprise at least one subject permutation. The subject permutation can comprise at least one subject diagnosis code associated with the first healthcare classification system and at least one subject procedure code associated with the first healthcare classification system.

At 850, one or more of the plurality of mapping rules can be applied to the at least one subject permutation to generate at least one replacement permutation. The replacement permutation can comprise at least one replacement diagnosis code associated with the second healthcare classification system and at least one replacement procedure code associated with the second healthcare classification system.

At 860, replacement healthcare claim data can be generated that replaces the received subject healthcare claim data. The replacement healthcare claim data can comprise the at least one replacement permutation. A total payment amount associated with the received subject healthcare claim data can substantially similar to, or equal to, a total payment amount associated with the generated replacement healthcare claim data.

Exemplary methods disclosed herein can include one or more of 810 through 860. For example, in some exemplary methods, all of the acts in FIG. 8 can be included. In other examples, one or more of 810 through 860 can be excluded.

### Example 18

### Exemplary Applications

Financial neutrality can be desirable in a variety of circumstances. For example, insurance underwriters may wish to preserve financial neutrality in the face of new regulations until sufficient data can be collected under the new regulations to determine new insurance rates and policies.

The systems and methods described herein can provide a means for healthcare entities to modify their software systems and modify healthcare records, claims and data to account for legislative changes and/or changes in industry classification standards, such as the government mandated change from ICD-9 to ICD-10, as well as inevitable similar future changes. Using the disclosed technology to migrate to the newer classification system can help a provider better determine payment amounts and can also improve fraud determination. Furthermore, the disclosed technology can provide claim-to-claim mapping that results in financial neutrality without additional data such as age, gender, length of stay, etc. Furthermore, the computer-implement nature of the disclosed technology can help avoid the time-consuming and error-prone task of manually converting codes between classification systems.

Alternative embodiments of the disclosed technology can convert healthcare codes between classification systems and result in objectives other than financial neutrality, such as claim data accuracy, clinical accuracy (such as determined by a doctor), total number of codes, optimization of time or resources, etc.

### Example 19

### Exemplary Computing Device

The techniques and solutions described herein can be performed by software and/or hardware of a computing environment, such as a computing device. For example, computing devices include server computers, desktop computers, laptop computers, notebook computers, netbooks, tablet devices, mobile devices, and other types of computing devices (e.g., devices such as televisions, media players, or other types of entertainment devices that comprise computing capabilities such as audio/video streaming capabilities and/or network access capabilities). The techniques and solutions described herein can be performed in a cloud computing environment (e.g., comprising virtual machines and underlying infrastructure resources).

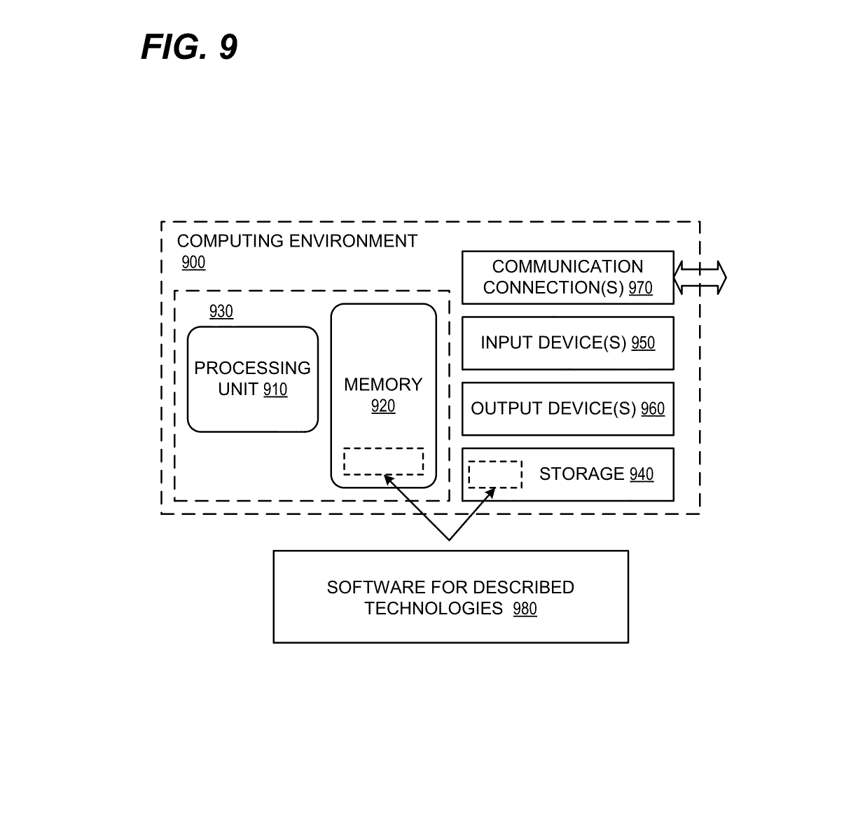

FIG. 9 illustrates a generalized example of a suitable computing environment 900 in which described embodiments, techniques, and technologies may be implemented. The computing environment 900 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, or the like. The disclosed technology may also be practiced in distributed computing environments where tasks are performed by remote processing devices that are linked through a communications network. In a distributed computing environment, program modules may be located in both local and remote memory storage devices.

With reference to FIG. 9, the computing environment 900 includes at least one central processing unit 910 and memory 920. In FIG. 9, this most basic configuration 930 is included within a dashed line. The central processing unit 910 executes computer-executable instructions. In a multi-processing system, multiple processing units execute computer-executable instructions to increase processing power and as such, multiple processors can be running simultaneously. The memory 920 may be volatile memory (e.g., registers, cache, RAM), non-volatile memory (e.g., ROM, EEPROM, flash memory, etc.), or some combination of the two. The memory 920 stores software 980 that can, for example, implement the technologies described herein. A computing environment may have additional features. For example, the computing environment 900 includes storage 940, one or more input devices 950, one or more output devices 960, and one or more communication connections 970. An interconnection mechanism (not shown) such as a bus, a controller, or a network, interconnects the components of the computing environment 900. Typically, operating system software (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other tangible storage medium which can be used to store information and which can be accessed within the computing environment 900. The storage 940 stores computer-executable instructions for the software 980, which can implement technologies described herein.

The input device(s) 950 may be a touch input device, such as a keyboard, keypad, mouse, pen, or trackball, a voice input device, a scanning device, or another device, that provides input to the computing environment 900. For audio, the input device(s) 950 may be a sound card or similar device that accepts audio input in analog or digital form, or a CD-ROM reader that provides audio samples to the computing environment 900. The output device(s) 960 may be a display, printer, speaker, CD-writer, or another device that provides output from the computing environment 900.

The communication connection(s) 970 enable communication over a communication medium (e.g., a connecting network) to another computing entity. The communication medium conveys information such as computer-executable instructions, compressed graphics information, or other data in a modulated data signal.

### Example 20

### Exemplary Alternatives and Variations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable media (tangible computer-readable storage media, such as one or more optical media discs, volatile memory components (such as DRAM or SRAM), or nonvolatile memory components (such as hard drives)) and executed on a computing device (e.g., any commercially available computer, including smart phones or other mobile devices that include computing hardware). By way of example, computer-readable media include memory 920 and/or storage 940. As should be readily understood, the term computer-readable media does not include communication connections (e.g., 970) such as modulated data signals.

Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to a particular type of hardware. Certain details of suitable computers and hardware are well known and need not be set forth in detail in this disclosure.

Furthermore, any of the software-based embodiments (comprising, for example, computer-executable instructions for causing a computing device to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed towards all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. In view of the many possible embodiments to which the principals of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method implemented at least in part by a computing device, the method comprising:
receiving historical healthcare claim data comprising at least one historical diagnosis code and at least one historical procedure code belonging to a first healthcare classification system;
receiving a historical payment code that is associated with the at least one historical diagnosis code and the at least one historical procedure code;
determining a plurality of candidate diagnosis codes belonging to a second healthcare classification system, the candidate diagnosis codes being mapped to the at least one historical diagnosis code;
determining a plurality of candidate procedure codes belonging to the second healthcare classification system, the candidate procedure codes being mapped to the at least one historical procedure code;
determining a plurality of candidate payment codes that are based on permutations of the candidate diagnosis codes and the candidate procedure codes; and
from among the candidate payment codes, selecting a most financially neutral candidate payment code with respect to the historical payment code.

2. The method of claim 1, wherein selecting a most financially neutral candidate payment code comprises:
comparing a first payment factor associated with the historical payment code with second payment factors associated with respective of the candidate payment codes; and
from among the candidate payment codes, selecting a candidate payment code that has an associated respective second payment factor that is most similar to the first payment factor.

3. The method of claim 1, further comprising:
generating a plurality of permutations of the candidate diagnosis codes in combination with the candidate procedure codes;
wherein determining a plurality of candidate payment codes comprises, for a given permutation from among the permutations, determining a respective candidate payment code for the given permutation.

4. The method of claim 3, wherein generating a plurality of permutations of the candidate diagnosis codes in combination with the candidate procedure codes comprises weighting the permutations in favor of a principal code.

5. The method of claim 4, wherein:
weighting the permutations in favor of the principal code comprises:
skipping at least one permutation comprising a non-principal code when generating the permutations.

6. The method of claim 5, wherein the skipping is throttled by a weighting factor.

7. The method of claim 1, further comprising:
selecting one of the candidate diagnosis codes and one of the candidate procedure codes that together are associated with the selected candidate payment code.

8. The method of claim 7, further comprising:
generating a mapping rule that correlates an original permutation comprising the at least one historical diagnosis code and the at least one historical procedure code with a replacement permutation comprising the selected candidate diagnosis code and the selected candidate procedure code.

9. The method of claim 8, further comprising:
generating a plurality of such mapping rules that correlate a plurality of original permutations comprising historical diagnosis codes and historical procedure codes with a plurality of respective replacement permutations comprising selected candidate diagnosis codes and selected candidate procedure codes, wherein the plurality of mapping rules minimize financial impact of migrating from the first healthcare classification system to the second healthcare classification system.

10. The method of claim 9, further comprising:
receiving subject healthcare claim data to be converted from the first healthcare classification system to the second healthcare classification system, the subject healthcare claim data comprising at least one subject permutation, the at least one subject permutation comprising at least one subject diagnosis code associated with the first healthcare classification system and at least one subject procedure code associated with the first healthcare classification system; and
applying the plurality of mapping rules to the at least one subject permutation to generate at least one replacement permutation, the at least one replacement permutation comprising at least one replacement diagnosis code associated with the second healthcare classification system and at least one replacement procedure code associated with the second healthcare classification system.

11. The method of claim 10, further comprising:
generating replacement healthcare claim data that replaces the received subject healthcare claim data, the replacement healthcare claim data comprising the at least one replacement permutation, wherein a total payment amount associated with the received subject healthcare claim data is substantially similar to, or equal to, a total payment amount associated with the generated replacement healthcare claim data.

12. The method of claim 1, wherein:
determining the candidate diagnosis codes and the candidate procedure codes comprises applying a General Equivalency Mapping, which maps codes of the first healthcare classification system to codes of the second healthcare classification system that represent overlapping subject matter.

13. The method of claim 1, wherein:
the second healthcare classification system has a greater granularity than the first healthcare classification system.

14. The method of claim 1, wherein:
the first healthcare classification system is one version of the International Classification of Diseases (ICD) and the second healthcare classification system is another version of ICD.

15. The method of claim 2, wherein:
responsive to determining that none of the candidate payment codes has an associated second payment amount that is equal to the first payment amount, flagging the received historical healthcare claim data for manual analysis.

16. The method of claim 1, wherein:
the at least one historical diagnosis code comprises an historical primary diagnosis code and one or more historical secondary diagnosis codes, and the at least one historical procedure code comprises an historical principal procedure code and one or more historical ancillary procedure codes;
the plurality of candidate diagnosis codes comprise one or more candidate primary diagnosis codes that are mapped to the historical primary diagnosis code, and one or more candidate secondary diagnosis codes that are mapped to the one or more historical secondary diagnosis codes; and
the plurality of candidate procedure codes comprise one or more candidate principal procedure codes that are mapped to the historical principal procedure code, and one or more candidate ancillary procedure codes that are mapped to the one or more historical ancillary procedure codes.

17. The method of claim 16, wherein the permutations that the plurality of candidate payment codes are based on comprise a subset of a set of possible permutations, each permutation in the set of the possible permutations comprising at least one candidate diagnosis code and at least one candidate procedure code, each permutation in the subset comprising at least one candidate primary diagnosis code or at least one candidate principal procedure code.

18. The method of claim 17, wherein:
permutations in the subset comprise at least one respective candidate primary diagnosis code and at least one respective candidate principal procedure code.

19. A computing system comprising a processor and a memory, the memory storing computer-executable instructions that when executed cause the computing system to perform a method, the method comprising:
receiving historical healthcare claim data comprising a plurality of historical healthcare codes associated with a first healthcare classification system, the plurality of historical healthcare codes representing diagnoses, procedures, or diagnoses and procedures relating to a patient, the plurality of historical healthcare codes being associated with a first total payment amount;
determining a plurality of candidate healthcare codes associated with a second healthcare classification system, the candidate healthcare codes being mapped to the historical healthcare codes, wherein a plurality of different permutations of the candidate healthcare codes are associated with a plurality of respective second total payment amounts;
selecting one of the plurality of permutations that is associated with a second total payment amount that is most similar to the first total payment amount associated with the historical healthcare codes of the received historical healthcare claim data; and
generating a mapping rule that correlates the historical healthcare codes with the selected permutation of candidate healthcare codes.

20. The computing system of claim 19, wherein the method further comprises:
receiving subject healthcare claim data to be converted from the first healthcare classification system to the second healthcare classification system, the subject healthcare claim data comprising at least one subject permutation comprising a plurality of subject healthcare codes associated with the first healthcare classification system;
applying the mapping rule to the at least one subject permutation to generate at least one replacement permutation comprising a plurality of replacement healthcare codes associated with the second healthcare classification system; and
generating replacement healthcare claim data that replaces the received subject healthcare claim data, the replacement healthcare claim data including the at least one replacement permutation, wherein a total payment amount associated with the received subject healthcare claim data is substantially similar to, or equal to, a total payment amount associated with the generated replacement healthcare claim data.

21. The computing system of claim 19, wherein:
the plurality of historical healthcare codes comprises an historical primary diagnosis code and an historical principal procedure code;
the plurality of candidate healthcare codes comprises one or more candidate primary diagnosis codes that are mapped to the historical primary diagnosis code and one or more candidate principal procedure codes that are mapped to the historical principal procedure code; and
the permutations that the plurality of respective second total payment amounts are associated with respectively comprise at least one candidate primary diagnosis code or at least one candidate principal procedure code.

22. One or more computer readable media storing computer-executable instructions that when executed cause a computing device to perform a method, the method comprising:
receiving historical healthcare claim data based on a first healthcare classification system, the historical healthcare claim data comprising a first diagnosis code based on the first healthcare classification system, a first procedure code based on the first healthcare classification system, and a first Diagnosis-Related Group (DRG) code based on the first diagnosis code and the first procedure code;
determining a set of second diagnosis codes based on a second healthcare classification system, the set of second diagnosis codes being associated with the first diagnosis code, and a set of second procedure codes based on the second healthcare classification system, the set of second procedure codes being associated with the first procedure code;
determining a set of second DRG codes that are based on permutations of the second diagnosis codes and the second procedure codes;
determining a set of payment amount differences between payment amounts associated with the set of second DRG codes and a payment amount associated with the first DRG code;
determining a smallest payment amount difference of the set of payment amount differences, selecting one of the set of second DRG codes that corresponds to the smallest payment amount difference, and selecting one of the set of second diagnosis codes and one of the set of second procedure codes that together are associated with the selected second DRG code; and
generating a rule that correlates a first permutation comprising the first diagnosis code and the first procedure code with a second permutation comprising the selected second diagnosis code and the selected second procedure code.
